(19) United States
(12) Patent Application Publication
(10) Pub. No.: US 2015/0176489 A1
(43) Pub. Date: Jun. 25, 2015

(54) Unknown

(71) Applicants: Ulrich Damgen, Iserlohn (DE); Thorsten Meier, Detmold (DE)

(72) Inventors: Ulrich Damgen, Iserlohn (DE); Thorsten Meier, Detmold (DE)

(73) Assignee: Boge Kompressoren Otto Boge GmbH & Co. KG, Bielefeld (DE)

(21) Appl. No.: 14/135,634

(22) Filed: Dec. 20, 2013

(51) Int. Cl. F02C 6/16

(52) U.S. Cl. CPC F02C 6/16

(57) ABSTRACT

The invention relates to a device for producing compressed air or other pressurized gases, having at least one high pressure compressor (12) and one low pressure compressor (11), and, in particular, a downstream gas store (reservoir 13). According to the invention, the high pressure compressor is a turbomachine with adjustable guide vanes and is flowed through alternately in one direction as a compressor or in the other direction as an expansion machine.

### BACKGROUND OF THE INVENTION

1. Technical Field

The invention relates to a device for producing compressed air or other pressurized gases, having at least one high pressure compressor and at least one low pressure compressor, and, in particular, a downstream gas store.

2. Prior Art

A known way of producing compressed air is to compress the air in several stages, starting from the normal pressure of the surroundings, since compression to a higher pressure by means of just one stage is uneconomical and/or is associated with technical problems, which can be avoided by multistage compression.

The compressed air is typically stored in a reservoir and discharged from the reservoir as required. If there is a lot of fluctuation in demand, large pressure differences can arise in the reservoir. Economical production of the compressed air with the maximum efficiency is correspondingly difficult.

### BRIEF SUMMARY OF THE INVENTION

It is the object of the present invention to provide a device for the economical production of compressed air, in particular with greatly fluctuating pressure ratios.

A device according to the invention is a device for producing compressed air or other pressurized gases, having at least one high pressure compressor and at least one low pressure compressor, and, in particular, a downstream gas store (reservoir), wherein the high pressure compressor is a turbomachine with adjustable guide vanes and is flowed through alternately in one direction as a compressor or in the other direction as an expansion machine. According to this, the high pressure compressor is a turbomachine, in particular a turbomachine of radial construction, with adjustable guide vanes and can be flowed through alternately in one direction as a compressor or in the other direction as an expansion machine. The low pressure compressor is preferably used to produce compressed air of virtually constant pressure or narrow bandwidth. In contrast, the high pressure compressor makes available compressed air with relatively large pressure differences.

For example, compressed air at about 40 to 100 bar is to be available on the high pressure side of the high pressure compressor. The low pressure compressor provides compression to about 20 bar, for example, while the high pressure compressor approximately doubles this pressure or multiplies it up to about fivefold. The required variability of the turbomachine is achieved by adapting the speed, in particular as a function of the pressure ratio (high pressure side to low pressure side of the turbomachine), and adjusting the guide vanes between the blade wheel and the spiral, thus making it possible to achieve different mass flows. Adjusting guide vanes between a blade wheel and a spiral in a turbomachine of radial construction allows particularly good adaptation to the changing rate of radial flow of the kind which occurs on the high pressure side of the high pressure compressor in the case of varying pressure.

In certain applications, the compressed air required can be of significantly lower pressure than the compressed air stored. An electric drive machine which can also operate as a generator is therefore advantageously assigned to the high pressure compressor. This preferably also applies to the low pressure compressor, especially if this is flowed through alternately as a compressor or as an expansion machine. During the removal of the compressed air from the reservoir, the compressed air can be passed through the high pressure compressor and, if appropriate, also the low pressure compressor, producing electric energy in the process. For this purpose, too, the construction of the turbomachine of the high pressure compressor with adjustable guide vanes is advantageous. Despite widely differing pressure ratios, electric energy can be produced with high efficiency as the compressed air is discharged from the store.

In the device according to the invention, it is possible, in particular, for a turbomachine or a piston machine with reciprocating pistons or rotary pistons, in particular a screw compressor, to be provided as a low pressure compressor. When a turbomachine is used, it preferably has fixed guide vanes or no guide vanes.

According to another concept of the invention, a branch leading to a turbine is provided between the high pressure compressor and the low pressure compressor, wherein the turbine can be assigned a combustion chamber, and wherein the turbine is connected, in particular, to an electric generator. As the compressed air is discharged from the store, it can perform work in the high pressure compressor and can drive a motor-generator. The compressed air emerging on the low pressure side of the high pressure compressor can be passed through a further turbine with an associated generator. The compressed air is preferably heated in a combustion chamber on the way to the further turbine. This improves the overall efficiency of the further turbine. It may also be advantageous for the overall efficiency of the device to divide up the tasks between the low pressure compressor with a drive motor and the further turbine with a generator.

The invention also relates to a method for producing and/or storing compressed air or other gases in reservoirs, using a device of the kind explained above, taking account of the various embodiments and alternatives.

The device explained above can be used to particular advantage for a method for the indirect storage of electric energy by compression and expansion of compressed air or other gases. Precisely when storing electric energy by means of compressed air, high pressure differences can arise in the store. Geological formations can also be provided as stores. The term “reservoir” (for the storage of gases) is therefore to be understood in the widest sense and also includes naturally occurring or artificially produced cavities under the surface of the earth. In the narrowest sense, it is a vessel with a thick wall.

The high pressure compressor is preferably operated at a pressure ratio of between 1.5 and 4. The pressure ratio refers to the pressure on the high pressure side of the high pressure compressor relative to the pressure on the low pressure side of the high pressure compressor. In this context, it is assumed that the pressure on the low pressure side of the high pressure compressor corresponds substantially to the pressure on the high pressure side of the low pressure compressor, which in this case is preferably assumed to be from 10 to 60 bar, e.g. 20 bar, with a pressure which is, in particular, as constant as possible.

A quotient of the maximum and minimum pressure ratio of the high pressure compressor is preferably greater than 1.3, in particular greater than 1.8.

It is advantageous if the gas is heated with fuel during expansion after leaving the high pressure compressor—which in this case operates as an expansion turbine—and is fed to a turbine having a generator. This improves efficiency especially when recovering electric energy.

According to another concept of the invention, the pressure on the high pressure side of the low pressure compressor fluctuates by less than +/−15%, preferably less than 5%, around the mean value thereof. In particular, the pressure on the high pressure side of the high pressure compressor fluctuates by more than +/−20%, preferably by over +/−30%, around the mean value thereof.

To improve efficiency, provision can furthermore be made for the pressure to be somewhat higher on the low pressure side of the high pressure compressor in expansion mode than in compression mode. This is possible by adapting the speed and adjusting the guide vanes of the turbomachine of the high pressure compressor. The advantage is that the mass flow through the low pressure compressor, which is then operating as a turbine, is increased, that its rated power can be fully exploited, and that its operating point can be shifted from the optimum for compressors to the optimum for expansion machines at the same speed in the Cordier diagram. It is envisaged here that, in expansion mode, the low pressure compressor will also drive a generator or that a further turbine with a generator is assigned as a low pressure machine.

A device and a method according to the invention can furthermore be supplemented by measures known per se for treating the compressed air. Thus, steam traps and/or dryers for removing moisture from the compressed gas can be provided on the high pressure sides, in particular, of the two compressors. Moreover, coolers or heat exchangers for dissipating heat from the compressed gas can be provided. Temporary storage of the dissipated heat and recovery in expansion mode is also possible. Heat storage and recovery in conjunction with the indirect storage of electric energy by devices from the applicant, as disclosed in German Utility Models DE 20 2011 106 400 and DE 20 2011 106 852, are particularly advantageous. The content of the cited utility models is hereby incorporated explicitly by reference into the present invention.

Switching and control valves can be provided between the reservoir and the high pressure turbine or at some other point. The speed of the motor for driving the high pressure compressor is adjustable. This is also possible for the motor for driving the low pressure compressor.

In connection with the low pressure compressor, the customary control methods can be employed, such as keeping the valves open in the case of a reciprocating piston, an intake throttle regulator or control slide for volume/revolutions in the case of a screw compressor. If the low pressure compressor is a turbomachine or a turbocompressor, this can also be constructed for a virtually constant pressure and mass flow without adjustable guide vanes and hence can be of less complex construction.

The high pressure compressor with adjustable guide vanes is, in particular, of single stage design but can also consist of two or more turbo stages arranged in series. For example, a turbo stage with adjustable guide vanes can be mounted at each of two shaft ends of a motor-generator, the speed of which can preferably be adjusted, wherein the two turbo stages are arranged in series in terms of flow.

The invention is not restricted to use in connection with compressed air. On the contrary, the compression and, if appropriate, expansion of other gases is also addressed.

### BRIEF DESCRIPTION OF THE DRAWINGS

Further features of the invention will become apparent from the rest of the description and from the claims. Advantageous embodiments of the invention are explained in greater detail below with reference to drawings, in which:

FIG. 1 shows a functional diagram including a low pressure compressor, a high pressure compressor and a storage reservoir,

FIG. 2 shows a cross section through the high pressure compressor in FIG. 1 in accordance with the line II-II, and

FIG. 3 shows a functional diagram of another embodiment, namely one having a further turbine and a combustion chamber arranged ahead of the latter.

### DETAILED DESCRIPTION OF PREFERRED EMBODIMENTS

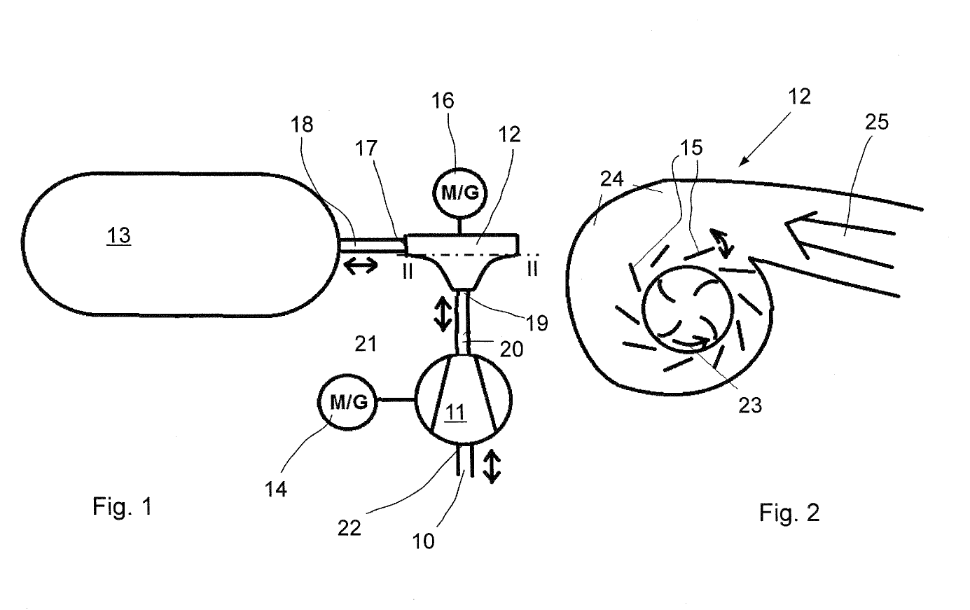

According to FIG. 1, air under normal pressure in a line 10 is compressed by a low pressure compressor 11 and a subsequent high pressure compressor 12 and stored in a reservoir 13. The low pressure compressor 11 is preferably a piston compressor or a screw compressor and is driven by an electric machine 14. A turbomachine can also be advantageous.

The high pressure compressor 12 is a turbomachine with adjustable guide vanes 15. Here too, an electric machine 16 is provided as a drive.

The guide vanes 15 preferably have pointed ends on both sides or have pointed design at both ends, meaning that an angle of less than 70°, preferably less than 40°, can be seen in cross section. Flow without flow separation or without a stagnant zone is thereby made possible in both directions of flow.

The device is designed for compression and expansion. Accordingly, both electric machines are provided as a motor and a generator, or at least electric machine 16 of the high pressure compressor 12.

A high pressure side 17 of the high pressure compressor 12 is connected by a line 18 to the reservoir 13. A low pressure side 19 of the high pressure compressor 12 is connected by a line 20 to a high pressure side 21 of the low pressure compressor 11. A low pressure side 22 of the low pressure compressor 11 is connected to line 10.

The high pressure compressor 12 is designed as a radial turbine with a blade wheel 23 in a spiral 24, wherein said guide vanes 15 are arranged in the spiral 24. FIG. 2 shows the high pressure compressor in operation as a turbine, i.e. during expansion of the compressed air stored in the reservoir 13. This air flows into the spiral 24 in the direction of an arrow 25 and drives the blade wheel 23.

In a manner not shown specifically, coolers, dryers or switching valves can be provided in the region of the pressurized lines 20, 18. A heat storage device for air cooling/air heating can also be provided. The compressed air in the reservoir 13 is significantly warmer in the case of compression without cooling than the air in the region of line 10. The heat is dissipated via the wall of the reservoir 13 and is lost. It is expedient, therefore, if the heat is dissipated from the compressed air before storage in the reservoir 13. When the compressed air is discharged from the reservoir 13, the heat of the compressed air is fed in again, in particular in the region of lines 18 and 20 and, if appropriate, also in the region of line 10.

In contrast to the illustration in FIG. 1, the high pressure compressor 12 with adjustable guide vanes can be not only of the single-stage type but can also consist of two or more turbo stages arranged in series. For example, a turbo stage with adjustable guide vanes can be mounted at each of the two shaft ends of the motor-generator 16 shown in FIG. 1, wherein the two turbo stages are arranged in series in terms of flow. The speed of the motor-generator 16 is preferably adjustable.

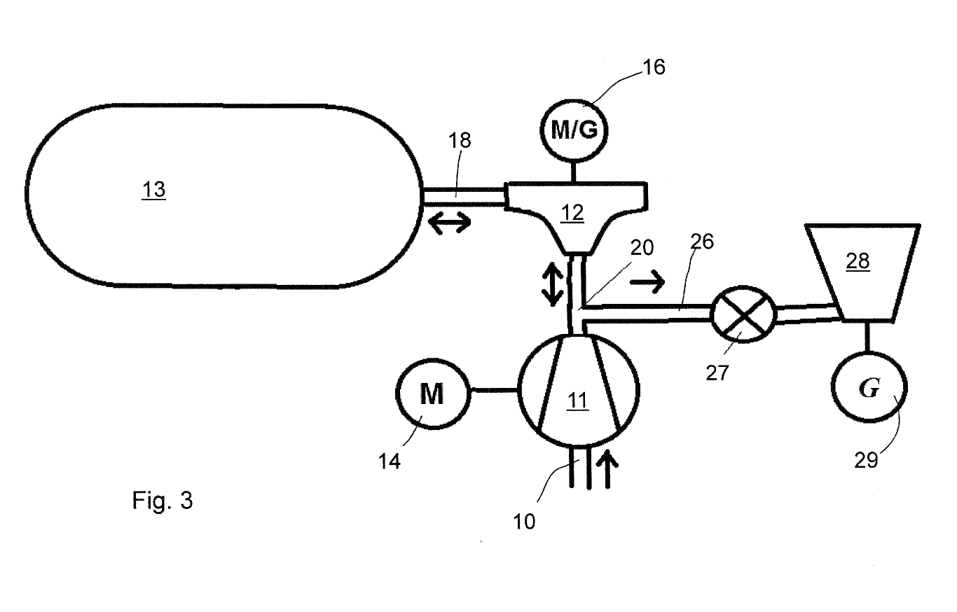

In the embodiment shown in FIG. 3, the line 20 between the high pressure compressor 12 and the low pressure compressor 11 has a branch 26, having a combustion chamber 27 and a subsequent turbine 28, which is assigned a generator 29. In this case, it is preferable if only a motor is assigned to the low pressure compressor 11 as an electric machine.

As in FIG. 1, the storage of the compressed air in the reservoir 13 is accomplished by means of the low pressure compressor 11 and the high pressure compressor 12. During discharge from storage, the compressed air expands via the high pressure compressor 12 running as a turbine, is heated in the combustion chamber 27 and flows through the turbine 28 to the drive of the generator 29. For this purpose, the low pressure compressor 11 can be closed in the region of the high pressure side 21 thereof, either when stationary by virtue of its design or by means of a valve.

Where the power of the installation is much greater in expansion mode than in compression, expansion can be performed simultaneously in parallel by the low pressure compressor 11 and the turbine 28. A quick start valve, which directs gas out of the reservoir 13 into line 20 while bypassing the high pressure compressor 12, is also possible.

### LIST OF REFERENCE NUMERALS

10 line
11 low pressure compressor
12 high pressure compressor
13 reservoir
14 electric machine
15 guide vanes
16 electric machine
17 high pressure side (high pressure compressor)
18 line
19 low pressure side (high pressure compressor)
20 line
21 high pressure side (low pressure compressor)
22 low pressure side (low pressure compressor)
23 blade wheel
24 spiral
25 arrow
26 branch
27 combustion chamber
28 turbine
29 generator

What is claimed is:

1. A device for producing compressed air or other pressurized gases, having at least one high pressure compressor (12) and at least one low pressure compressor (11), and, in particular, a downstream gas store (reservoir 13), wherein the high pressure compressor (12) is a turbomachine with adjustable guide vanes (15) and is flowed through alternately in one direction as a compressor or in the other direction as an expansion machine.

2. The device as claimed in claim 1, wherein the speed of the high pressure compressor can be set in a variable manner, in particular as a function of the pressure ratio of a high pressure side to the low pressure side of the high pressure compressor.

3. The device as claimed in claim 1, wherein the high pressure compressor is a radial turbomachine with a blade wheel and a spiral, and wherein the adjustable guide vanes are arranged between the blade wheel and the spiral.

4. The device as claimed in claim 1, wherein the high pressure compressor (12) is assigned a motor-generator as an electric drive.

5. The device as claimed in claim 1, wherein the low pressure compressor can also be flowed through alternately as a compressor or as an expansion machine, wherein the low pressure compressor is preferably assigned a motor-generator as an electric drive.

6. The device as claimed in claim 1, wherein a branch (26) leading to a turbine (28) is provided between the high pressure compressor (12) and the low pressure compressor (11), wherein the turbine (28) can be assigned a combustion chamber (27), and wherein the turbine (28) is connected, in particular, to an electric generator (29).

7. A method for producing and/or storing compressed air or other gases in reservoirs (13), using a device as claimed in claim 1.

8. A method for the indirect storage of electric energy by compression and expansion of compressed air or other gases and by using a device as claimed in claim 1.

9. The method as claimed in claim 7, wherein the high pressure compressor (12) is operated at a pressure ratio of between 1.5 and 4.

10. The method as claimed in claim 7, wherein a quotient of the maximum and minimum pressure ratio of the high pressure compressor is greater than 1.3, in particular greater than 1.8.

11. The method as claimed in claim 7, wherein the pressure on the high pressure side (21) of the low pressure compressor (11) fluctuates by less than +/−15%, preferably less than +/−5%, around the mean value thereof.

12. The method as claimed in claim 7, wherein the pressure on the high pressure side (17) of the high pressure compressor (12) fluctuates by more than +/−20%, preferably by over +/−30%, around the mean value thereof.

13. The method as claimed in claim 7, wherein the gas is heated with fuel during expansion after leaving the high pressure compressor (12) and is fed to a turbine (28) having a generator (29).

14. The method as claimed in claim 8, wherein the high pressure compressor (12) is operated at a pressure ratio of between 1.5 and 4.

15. The method as claimed in claim 8, wherein a quotient of the maximum and minimum pressure ratio of the high pressure compressor is greater than 1.3, in particular greater than 1.8.

16. The method as claimed in claim 8, wherein the pressure on the high pressure side (21) of the low pressure compressor (11) fluctuates by less than +/−15%, preferably less than +/−5%, around the mean value thereof.

17. The method as claimed in claim 8, wherein the pressure on the high pressure side (17) of the high pressure compressor (12) fluctuates by more than +/−20%, preferably by over +/−30%, around the mean value thereof.

18. The method as claimed in claim 8, wherein the gas is heated with fuel during expansion after leaving the high pressure compressor (12) and is fed to a turbine (28) having a generator (29).
